(19) United States
(12) Patent Application Publication
(10) Pub. No.: US 2007/0283832 A1
(43) Pub. Date: Dec. 13, 2007

(54) IMPRINT CIRCUIT PATTERNING

(75) Inventor: STEVEN P. HOTELLING, SAN JOSE, CA (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: APPLE COMPUTER, INC., CUPERTINO, CA (US)

(21) Appl. No.: 11/552,746

(22) Filed: Oct. 25, 2006

Related U.S. Application Data
(60) Provisional application No. 60/804,382, filed on Jun. 9, 2006.

(51) Int. Cl. B41F 23/04

(52) U.S. Cl. 101/487

(57) ABSTRACT

An imprint circuit patterning technique that shrinks the minimum feature dimension of circuit features formed on plastic substrates is provided. The imprint circuit patterning technique may be applied to the fabrication of LCDs, particularly LCDs including integral touch sensing. Substrates having patterned substantially transparent electrodes for use with such touch-sensing LCDs and the touch-sensing LCDs are also provided.

### CROSS-REFERENCE TO RELATED APPLICATIONS

This claims priority to U.S. Provisional Patent Application No. 60/804,382, filed Jun. 9, 2006, entitled “Imprint Circuit Patterning,” which is incorporated by reference herein. This is also related to: U.S. Provisional Patent Application No. 60/804,361, entitled “Touch Screen Liquid Crystal Display,” filed Jun. 9, 2006, and U.S. patent application Ser. No. 10/840,862, titled “Multipoint Touch Screen,” filed on May 6, 2004, which are also incorporated by reference herein.

### BACKGROUND

Semiconductor and integrated circuit fabrication are highly developed arts. Recently, a variety of techniques, such as photolithography, laser etching, etc., have further developed for creating multi-layered structures of conductors, insulators, and semi-conductors for many types of electronic devices, from simple integrated circuits to microprocessors, and even liquid crystal displays (LCDs).

However, a particular area for advancement in this field has been perceived with respect to the techniques for fabrication of LCDs, and more particularly LCDs featuring integrated touch sensing, such as co-pending U.S. Patent Application No. 60/804,361, referenced above.

One area of interest relates to the replacement of glass substrates with plastic substrates. In the field of LCDs, and particularly touch-sensing LCDs, this replacement has a number of advantages, including potentially reduced cost, flexibility in the selection of dielectric materials for various layers, and a reduced thickness. However, patterning circuitry on plastic substrates with the same resolution as glass substrates can be difficult. For example, using current technology, the minimum feature dimensions on plastic substrates are on the order of 200 μm (e.g., using printed resist and wet etching). Laser ablation is an alternative technique that may attain 20 μm features; however, laser ablation equipment is relatively expensive and the ablation process creates significant debris, which is undesirable in a clean room setting. Conversely, features 5 μm and even smaller are easily attainable on glass. This is desirable for touch-sensing electrodes incorporated in a touch screen, as 20-30 μm features are visible to the human eye and therefore produce undesired decreases in the performance of the display.

### SUMMARY

In one aspect, the present invention can relate to a method for fabricating an imprinted substrate. The method may include providing a substrate, which may be translucent and, in some embodiments, substantially optically transparent. The substrate may then be imprinted by applying a tool having features formed thereon to the substrate in the presence of increased heat and/or pressure relative to normal room conditions. On this imprinted substrate, one or more materials may be deposited with varying degrees of uniformity to form a variety of structures. In one embodiment, the structures may be substantially transparent, substantially electrically conductive electrodes as would be used in a touch screen having integral touch sensing. Such structures may also include electrically conductive traces for routing electrical signals to and from the electrodes.

In another aspect, the invention can relate to a touch screen comprising a substantially optically transparent imprinted substrate, which can be processed by the above-described fabrication method. In some embodiments, the imprinted substrate may have a plurality of imprinted features on which a plurality of electrically isolated, substantially transparent electrodes can be formed. Additional structures, such as electrically conductive leads for routing electrical signals to and from the substrate can be formed by depositing conductive materials on the substrate.

### BRIEF DESCRIPTION OF THE DRAWINGS

The invention may best be understood by reference to the following description taken in conjunction with the accompanying drawings in which:

FIG. 1 is a sectional view of a polymer substrate on which a circuit will be patterned according to an embodiment of the invention.

FIG. 2 is a sectional view of the polymer substrate being imprinted according to an embodiment of the invention.

FIG. 3 is a sectional view of the imprinted substrate according to an embodiment of the invention.

FIG. 4A is a sectional view of the imprinted substrate having transparent conductive ITO deposited thereon according to an embodiment of the invention.

FIG. 4B is a top view of the imprinted substrate shown in FIG. 4A according to an embodiment of the invention.

FIG. 4C is a sectional view of the imprinted substrate having transparent conductive ITO deposited thereon in which the sputtering process results in ITO being deposited on the vertical walls of the plateaus according to an embodiment of the invention.

FIG. 5 is a sectional view of the imprinted substrate with ITO deposited thereon being shadow masked and having aluminum deposited thereon for connecting leads according to an embodiment of the invention.

FIG. 6 is a sectional view of the imprinted substrate having a clear-coat film added for index matching and protection of the ITO layer according to an embodiment of the invention.

### DETAILED DESCRIPTION

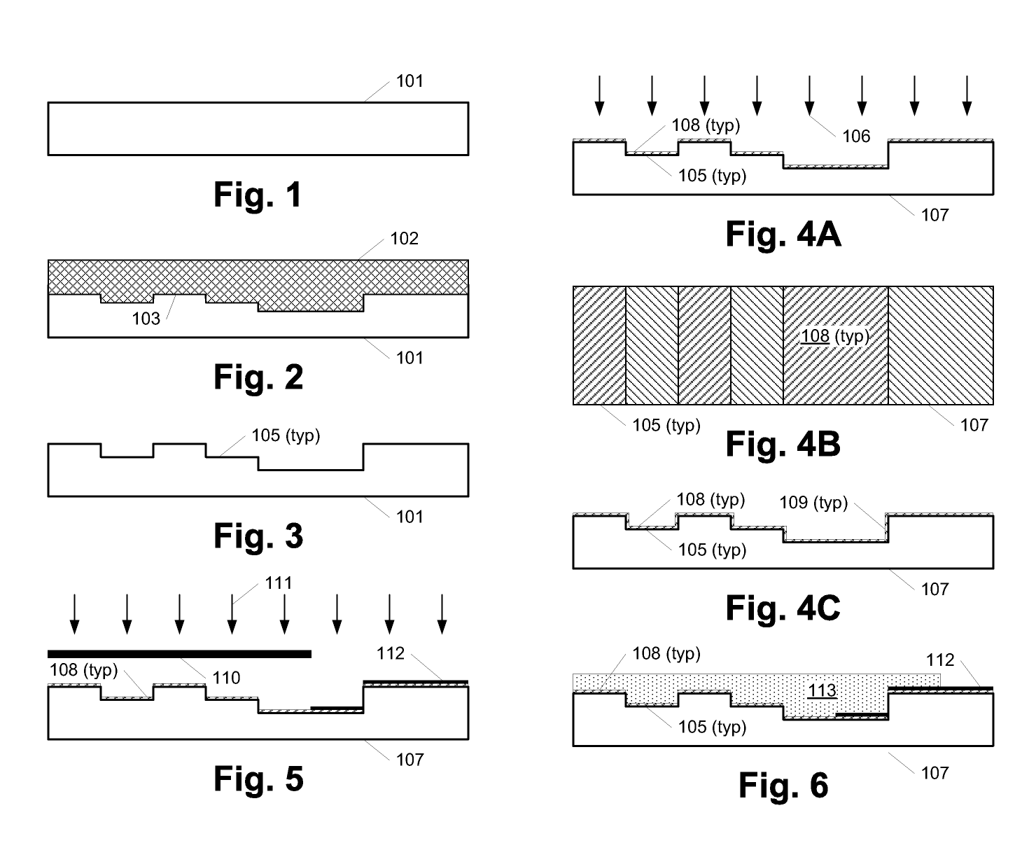

With reference now to FIGS. 1-6, an imprint circuit patterning technique is described. This technique may be employed in a variety of fabrication processes, but is believed to be particularly useful in fabricating a plastic substrate with touch-sensing electrodes for use in an LCD with integrated touch sensing as described in the references incorporated above. As used herein, “touch screen” refers to these and other types of display devices having touch-sensing capabilities.

FIG. 1 illustrates exemplary substrate 101. Substrate 101 may be formed from a polymer, such as polyester, acrylic, or polycarbonate Alternatively, substrate 101 may be formed from various other materials or combinations of materials selected on the basis of the particular characteristics desired. For example, in the context of an LCD with integrated touch sensing, the substrate material may be selected on the basis of its dielectric constant, which affects the performance of capacitive touch sensing electrodes. Another desirable characteristic in touch screen applications is that the substrate be substantially optically transparent, or translucent.

FIG. 2 illustrates tool 102, having a pattern formed thereon, being applied to polymer substrate 101 in the presence of increased heat and/or pressure relative to ordinary room temperatures and pressures. This imprints the features of tool 102 into substrate 101. Tool 102 need not be applied directly to substrate 101. One or more intervening materials may be present, so long as the force applied by tool 102 is transmitted to substrate 101 so as to form the impression of tool 102 in substrate 101. The imprinting process can be substantially similar to known micro-imprinting technology in use today, for example, in the manufacture of compact discs (CDs) and digital versatile disks (DVDs).

Tool 102 may be formed with features matching those of the desired application by the various known processes, such as laser engraving. Tool 102 may be formed from metal or any other material of sufficient rigidity to imprint substrate 101. The temperature and/or pressure used to imprint the substrate 101 with the features of tool 102 can vary depending on various factors, most notably, the substrate material.

FIG. 3 illustrates imprinted substrate 104, which results from the imprinting process. With current technological limitations, the minimum width of the imprinted features can be approximately 20-30 μm, although smaller features may be possible. Typically a feature having a physical dimension of 20-30 μm would be unacceptable for use in a touch screen application because features of this size are visible to the naked eye. However, as will be explained in greater detail below, the remainder of the processing steps can render this 20-30 μm feature substantially invisible in a touch screen application. The current state of the imprinting arts can allow approximately 1-2 μm vertical resolution for the imprinting process. Thus, the imprinting step according to one embodiment of this invention can result in a series of plateaus 105 having widths as small as approximately 20-30 μm, or less, and heights as low as approximately 1-2 μm, or less.

FIG. 4A illustrates a next step in the imprint circuit patterning process for fabricating electrodes for a touch screen. Other steps may be added as well, depending on the application. In a touch screen application, a plurality of electrically isolated translucent (e.g., substantially transparent), electrically conductive electrodes are needed. Historically, these electrodes have been formed on glass substrates by depositing a substantially uniform layer of a transparent conductive material, such as indium-tin-oxide (ITO), and then removing ITO to form the isolated electrodes. ITO removal has been performed by various known processes, such as photolithography and laser deletion.

However, according to one embodiment of the present method, a highly directional ITO sputtering technique 106 can be used to deposit ITO on plateaus 105 formed by the imprinting process. The deposited ITO can have a thickness of about 150 Å. The vertical separation (e.g., on the order of about 1-2 μm) between adjacent plateaus 105 can provide sufficient electrical isolation between adjacent electrodes 108, provided that ITO sputter 106 is sufficiently directional. Various techniques are known in the art to achieve highly directional sputters, including the use of collimators, etc.

As shown in FIG. 4B, a top view of the resulting substrate 107 with ITO deposited to a substantially uniform thickness reveals various physical characteristics. The adjacent electrically isolated electrodes 108 can have effectively zero horizontal separation, but are nonetheless electrically isolated. Furthermore, because each of adjacent plateaus 105 has a substantially uniform ITO coating, there is substantially no discernable difference in the transmission of light through one plateau versus another. These characteristics yield a surface that can be well suited for use in touch screen applications.

As illustrated in FIG. 4C, if the sputtering direction or imprint side-walls are not purely vertical, a thin layer of material may develop on the side-walls 109. This layer can electrically connect adjacent plateau regions. However, the vertical ITO coating will be much thinner than the ITO coating on the plateau regions 105. For example, a process that results in a 200 Å coating on the plateaus 105 may result in a 20 Å coating of ITO on the sidewalls 109. Therefore, to eliminate the undesired electrical connection between adjacent plateau regions, an isotropic etching process may be used to remove the ITO on the sidewalls 109. For example, if the etching process is timed to remove 40 Å, then the plateaus 105 can be thinned from 200 Å to 160 Å, while the undesired ITO on the side-wall regions 109 can be completely removed.

FIG. 5 illustrates an optional step in the fabrication process. Shadow mask 110 can be applied over portions of the surface (e.g., over patterned electrodes 108), and metal sputter 111, such as aluminum, chrome, molybdenum, copper, silver, or various alloys, can be applied to the unmasked areas to form low resistance, but opaque, traces for routing signals. An isotropic etching process similar to that described above may be used to remove undesired metal on the side-walls. These conductive traces may be formed over the ITO layer previously formed, on the substrate directly, or some combination thereof.

An exemplary use of such traces is in the border of an LCD and/or touch screen. The lower resistance of the metal (for example, 1Ω per square) compared to the ITO (for example 200Ω per square) can allow faster propagation of electrical signals for a given trace-width. This permits the use of metal routing in the border. When the resistance of ITO is not a problem, for example, this step may be omitted.

FIG. 6 illustrates another optional step in the exemplary process for fabricating a touch screen. In this process, a substantially clear coat thick film 113 can be placed over the surface. Clear coat film 113 can have a relatively high dielectric constant and can, for example, have a thickness on the order of about 3-10 μm. This film can be used for optical index matching, which can enhance performance of a display. The film further provides mechanical protection for ITO electrodes 108. Coating 113 may be deposited by any known process, such as spin coating, sputtering, inkjet printing, etc. Exposed portions of this coat may be generated by using a shadow mask during sputtering of the clear coat, or photolithography, for example. Exposed leads 112 (e.g., metal, ITO, etc.) may be used to attach flex circuits or other interconnect components that connect the formed structures to the remainder of an electronic device or system.

The processed substrate may then be combined with other layers to form an integrated touch sensing LCD or other touch screen.

Many other variations and/or combinations of the embodiments discussed herein will be apparent to those skilled in the art. For example, the manufacturing process described herein could find applicability in any number of fabrication operations, such as photolithography, nano-imprinting, and others.

It should also be noted that there are many alternative ways of implementing the techniques described herein. For example, the steps described herein may be performed in varying order or may be performed simultaneously. Additionally, the steps may be performed in different order, at different times or at the same time to various portions of the substrate, which may be overlapping, partially overlapping, or non-overlapping. Furthermore, portions of the substrate may only be subjected to certain processing steps, while other portions may be subjected to different processing steps. It is therefore intended that the following appended claims be interpreted as including all such alterations, permutations, combinations and equivalents.

What is claimed is:

1. A method for fabricating an imprinted substrate, the method comprising:
providing a substrate;
imprinting the substrate by applying a tool to the substrate in the presence of at least one of heat and pressure to form an imprinted substrate;
depositing at least a first material substantially uniformly on at least a first portion of the imprinted substrate; and
depositing at least a second material substantially non-uniformly on at least a second portion of the imprinted substrate.

2. The method of claim 1 wherein the first material and the second material are the same material.

3. The method of claim 1 wherein the first portion of the imprinted substrate and the second portion of the substrate at least partially overlap.

4. The method of claim 1 wherein the substrate is a transparent polymer.

5. The method of claim 4 further comprising integrating the imprinted substrate into a touch screen.

6. The method of claim 4 wherein depositing at least a first material substantially uniformly on at least a portion of the imprinted substrate includes sputtering ITO onto at least a portion of the imprinted substrate.

7. The method of claim 6 wherein depositing at least a first material substantially uniformly on at least a portion of the imprinted substrate includes removing ITO deposited on vertical surfaces of imprinted features.

8. The method of claim 6 wherein depositing at least a second material substantially non-uniformly on at least a portion of the imprinted substrate includes sputtering the second material onto at least a portion of the imprinted substrate.

9. The method of claim 8 wherein the second material is a metal.

10. The method of claim 8 wherein depositing at least a second material substantially non-uniformly on at least a portion of the imprinted substrate includes removing the second material deposited on vertical surfaces of imprinted features.

11. The method of claim 10 wherein the second material is a metal.

12. The method of claim 1 wherein depositing at least a second material substantially non-uniformly on at least a portion of the imprinted substrate includes sputtering the second material onto at least a portion of the imprinted substrate.

13. The method of claim 12 wherein depositing at least a second material substantially non-uniformly on at least a portion of the imprinted substrate includes removing the second material deposited on vertical surfaces of imprinted features.

14. The method of claim 4 further comprising:
depositing a substantially clear film on the imprinted substrate over at least a portion of the first and second materials deposited on the imprinted substrate.

15. The method of claim 14 further comprising integrating the imprinted substrate into a touch screen.

16. The method of claim 14 wherein depositing at least a first material substantially uniformly on at least a portion of the imprinted substrate includes sputtering ITO onto at least a portion of the imprinted substrate.

17. The method of claim 16 wherein depositing at least a first material substantially uniformly on at least a portion of the imprinted substrate includes removing ITO deposited on vertical surfaces of imprinted features.

18. The method of claim 14 wherein depositing at least a second material substantially non-uniformly on at least a portion of the imprinted substrate includes sputtering a metal onto at least a portion of the imprinted substrate.

19. The method of claim 18 wherein depositing at least a second material substantially non-uniformly on at least a portion of the imprinted substrate includes removing metal deposited on vertical surfaces of imprinted features.

20. A touch screen comprising:
a substantially transparent substrate having a plurality of imprinted features; and
a plurality of electrically isolated, substantially transparent electrodes formed by substantially uniformly depositing a substantially electrically conductive material on the plurality of imprinted features.

21. The touch screen of claim 20 further comprising:
a plurality of conductive traces formed by substantially non-uniformly depositing a conductive material on at least some of the imprinted features.

22. The touch screen of claim 21 further comprising:
an index matching substantially clear film deposited over the plurality of electrodes.

23. The touch screen of claim 20 further comprising:
an index matching substantially clear film deposited over the plurality of electrodes.

24. A method of fabricating a touch screen comprising:
providing a substantially transparent substrate;
imprinting the substantially transparent substrate by applying a tool to the substrate in the presence of at least one of heat and pressure;
forming a plurality of electrically isolated, substantially transparent electrodes by substantially uniformly depositing ITO on imprinted features of the substantially transparent imprinted substrate; and
forming a plurality of conductive traces by substantially non-uniformly depositing one or more materials on the imprinted substrate.

25. The method of claim 24 wherein the conductive traces are formed by substantially non-uniformly depositing ITO on the imprinted substrate.

26. The method of claim 24 wherein the conductive traces are formed by substantially non-uniformly depositing a metal on the imprinted substrate.

27. The method of claim 24 further comprising:
depositing an index matching substantially clear film on the substrate over the plurality of electrically isolated, substantially transparent electrodes.

28. The method of claim 27 further comprising integrating the substrate into a touch screen.
